(19) United States
(12) Patent Application Publication
(10) Pub. No.: US 2026/0265503 A1
(43) Pub. Date: Sep. 10, 2026

(54) WAD FOR CARTRIDGES WITH CHARACTERISTICS OF BIODEGRADABILITY IN SOIL

(71) Applicant: LB PLAST S.R.L., MAGIONE (PG) (IT)

(72) Inventors: Tommaso GUAZZINI, Magione (PG) (IT); Luca LANDINI, Magione (PG) (IT); Francesco SANDIAS, Magione (PG) (IT)

(73) Assignee: LB PLAST S.R.L., MAGIONE (PG) (IT)

(21) Appl. No.: 18/994,316

(22) PCT Filed: Jul. 17, 2023
(86) PCT No.: PCT/IT2023/050165

§ 371 Date: Jan. 14, 2025

(30) Foreign Application Priority Data
Jul. 15, 2022 (IT) 102022000014962

(51) Int. Cl. C08L 3/02; C08K 5/053; F42B 7/08

(52) U.S. Cl. CPC C08L 3/02; C08K 5/053; F42B 7/08; C08L 2201/06; C08L 2205/06; C08L 2310/00

(57) ABSTRACT

A wad for cartridges with characteristics of biodegradability in soil, produced with a mixture of biodegradable materials, the materials including poly(butylene succinate) (PBS) and poly(butylene adipate terephthalate) (PBAT), and the wad further including thermoplastic maize starch (TPS), previously obtained by extrusion of native maize starch with a plasticiser.

### FIELD

The present invention relates to a wad for cartridges with characteristics of biodegradability in soil. In particular, the invention relates to a wad for cartridges with characteristics of biodegradability in soil according to standard UNI EN ISO 17556:2019 (Determination of the ultimate aerobic biodegradability of plastic materials in soil by measuring the oxygen demand in a respirometer or the amount of carbon dioxide evolved).

The invention relates to the field of ammunition, in particular the production of plastic wads for cartridges with characteristics of biodegradability in soil and possible compostability.

### BACKGROUND

It is well known that wads for cartridges are an essential component of the cartridges themselves, and enable a significant degree of ballistic regularity to be achieved in terms of pressures and velocity, by fully exploiting the exhaust gases produced during the combustion of gunpowder, thanks to a perfect internal sealing of the cartridge, and more in particular of the casing, i.e. the part of the cartridge intended to contain mainly the propelling charge (gunpowder), the projectile (i.e. shot) and the primer, at the moment of firing a shot. Similarly, wads protect the projectiles in their trajectory from inside the barrel of the firearm, preventing the deformation thereof due to friction with the walls and at the moment of the explosion of the gunpowder.

In particular, wads constitute a thickness of resistant, elastic material, which separates the gunpowder in the casing from the shot column and are in general composed of a single structure made of polymeric material. A wad can be a simple shock absorber or an assembly of gas seals, shock absorber and shot cup.

Wads are generally made of a polyolefin material, typically PE or PP. In recent times, wads made of biodegradable material have been proposed which maintain the conditions required of wads, such as maximum pressure, velocity, and uniform ballistic qualities under the different conditions in which a shot can be fired.

However, despite the fact that wads generically declared to be “biodegradable” or declared to be compostable have been proposed on the market, to date there do not exist any commercially available wads that are biodegradable in soil and capable of satisfying the strict requirements defined according to the relevant standard UNI EN ISO 17556:2019. In fact, the wads used, once expelled from the shotgun, are to be found in precise environmental media: soil, or else water, should they end up in rivers or lakes. The wads will surely not be in composting conditions. For this reason, it is important that the wad be made of a material that is biodegradable in soil according to a recognised standard, such as the one defined in standard UNI EN ISO 17556:2019.

United States patent publication No. US2018/0274890 describes a shotgun wad made of biodegradable materials. The materials used to make the wads described in this publication are polyesters such as polyhydroxyalkanoate (PHA), polylactic acid (PLA), polycaprolactone (PCL), polybutylene succinate (PBS), poly (butylene succinate-co-adipate) (PBSA) or a polybutylene succinate copolymer other than adipate (PBSc). The authors of this publication declare that the wads described are biodegradable according to standard ASTM D6400, a document that describes industrial composting of plastics, or in any case they generically define biodegradability as the ability of a material to completely break down and return to nature within a reasonable amount of time. Furthermore, in the claims, patent publication No. US2018/0274890 defines a shell divided into two physically and chemically distinct zones: a powder wad and a wad for containing the shot.

Patent ES2535344 describes biodegradable shotgun shells made up of at least 50% biodegradable material and up to a maximum of 50% mineral fillers. According to the authors, the material is considered biodegradable if it meets standards for composting or in aqueous media: EN 13432 (Requirements for packaging recoverable through composting and biodegradation), EN 14855 (Determination of the ultimate aerobic biodegradability of plastics under controlled composting conditions), ASTM D6400-99, (Standard specification for compostable plastic), ASTM D5338-98 (Standard Test Method for Determining Aerobic Biodegradation of Plastic Materials Under Controlled Composting Conditions, including thermophilic temperatures) or ISO 14851 (Determination of the ultimate aerobic biodegradability of plastic materials in an aqueous medium).

Document EP 3875887 describes wadding made up of almost 98% biodegradable material, obtained by assembling various components, mainly cardboard, felt, cork or wood fibres in superposed slices or amalgamated with natural binders. According to the authors, this wadding is able to biodegrade or decompose in periods of even less than 15 days. This type of wadding cannot be injection moulded like a common thermoplastic material, implying a more difficult manufacturing process entailing assembly.

Furthermore, on the market there exist some wads declared to be biodegradable, but they only provide generic statements about the biodegradability of the materials.

Cardboard wads are also known in the sector, but despite complying with the requirements of biodegradability in soil, they do not compete with the ballistic performances typical of non-biodegradable polyolefin materials.

The prior art thus reveals the presence of materials generically defined as biodegradable or declared to be compostable. The wads that potentially meet the requirements of biodegradability are not satisfactory from a ballistic viewpoint. Wads having characteristics of biodegradation in soil, and which maintain the ballistic properties required for firing effective shots, are lacking in the prior art.

### SUMMARY

The solution according to the present invention fits into this context; it aims to provide injection-mouldable wads for cartridges with characteristics of biodegradability in soil (as per the definition contained in standard UNI EN ISO 17556:2019) and good ballistic properties, as well as with low production costs.

These and other results are achieved according to the present invention by proposing wads for cartridges with characteristics of biodegradability in soil, in particular produced with a ternary blend of biodegradable materials, in particular two biodegradable polyesters and a thermoplastic starch, namely the polyesters poly(butylene succinate) (PBS) and poly(butylene-adipate-terephthalate) (PBAT) and a thermoplastic maize starch (TPS). PBS is a semi-crystalline polymer, formed from the repetition of the units —[O—(CH₂)m-O—CO—(CH₂)n-CO]N, with m=4 and n=2; according to the following structural formula

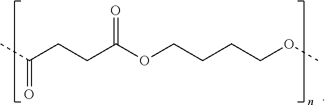

PBAT is a random biodegradable copolymer, in particular a copolyester of adipic acid, 1,4-butandiol and terephthalic acid, according to the following structural formula

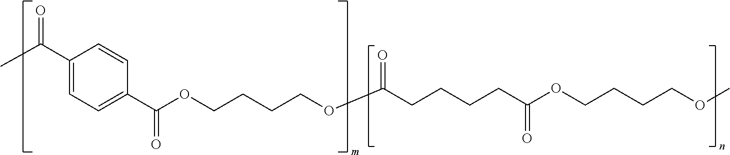

and the thermoplastic starch is a natural starch, a glucose polymer of plant origin composed of amylose and amylopectin, which has been subjected to a process of gelatinisation in an extruder in the presence of plasticisers such as water or glycerol (or 1, 2, 3 propanetriol), an organic compound characterised by the molecular formula C₃H₈O₃.

The aim of the present invention is thus to provide wads for cartridges with characteristics of biodegradability in soil that make it possible to overcome the limits of the wads for cartridges according to the prior art and to obtain the previously described technical results.

A further aim of the invention is that said wads for cartridges can be produced with substantially low costs, both as regards the production costs and as far as the management costs are concerned.

Yet a further aim of the invention is to propose wads for cartridges with characteristics of biodegradability in soil that are simple, safe and reliable, whose characteristics meet specifications of biodegradability in soil such as to be certified according to standard UNI EN ISO 17556:2019, and which are nontoxic both for the environment and for grazing animals that could accidentally ingest them. In particular, the composition of the elements constitutes an edible substrate that is easily digestible both by bovines and by ungulates in general.

The aim of the invention is thus to propose a nontoxic, biodegradable wad, which is easily processable in current moulding systems and has costs that are relatively acceptable to the current market.

Therefore, a specific aim of the present invention is a wad for cartridges with characteristics of biodegradability in soil, produced with a mixture of biodegradable materials, said materials comprising two biodegradable polyesters.

In particular, according to the invention, said biodegradable polyesters comprise poly(butylene succinate) (PBS) and poly(butylene adipate terephthalate) (PBAT) and can optionally further comprise thermoplastic maize starch (TPS), previously obtained by extruding native maize starch with a plasticiser.

Preferably, where said biodegradable polyesters comprise PBS and PBAT, but do not comprise TPS, said mixture comprises from 50 to 70% by weight of PBS and from 30 to 50% by weight of PBAT.

Alternatively, where said biodegradable polyesters comprise PBS, PBAT and TPS, said mixture comprises from 8 to 65% by weight of PBS, 12 to 50% by weight of PBAT and up to a maximum of 80% by weight of TPS, preferably 8 to 30% by weight of PBS, 12 to 40% by weight of PBAT and 30 to 80% by weight of TPS and more preferably 22.86% by weight of PBS, 34.28% by weight of PBAT and 42.86% by weight of TPS.

In particular, according to the present invention said thermoplastic maize starch (TPS) is produced starting from maize starch and glycerol, preferably starting from 70% by weight of maize starch and 30% by weight of glycerol. It is important that the thermoplastic starch is produced separately in a previous step. In fact, the extrusion of all the components in a single step could lead to an incomplete gelatinisation of the starch, as the other matrices could compete with the starch in the plasticisation caused by the plasticiser. A further aspect of the invention is the total absence of additives, such as, for example, coupling or compatibilizing agents, without which many blends of polymeric matrices, given their poor miscibility, fail to show significant mechanical properties. According to the prior art, in fact, the applications of mixtures of PBAT and TPS remain limited precisely because of their incompatibility, which can only be overcome through interventions such as the addition of compatibilizing agents or chemical modification of the polymers themselves (P. Wongphan et al., Food Packaging and Shelf Life 32 (2022) 100844).

Furthermore, according to the invention, said wad for cartridges is biodegradable in soil according to standard UNI EN ISO 17556:2019.

The importance of the wad for cartridges of the present invention is evident; it has a declarable biodegradability in soil, while maintaining the necessary ballistic properties (it does not break up during firing, maintains the gases generated by the gunpowder, and reaches a velocity of 400 m/s), the biodegradability being assured by the use of biodegradable polyesters and a certain content of thermoplastic starch.

Furthermore, the moulding of such materials is advantageous by virtue of the fact of allowing low moulding temperatures, which thus enable energy savings of about 30% compared to the moulding of traditional wads made with polyolefin materials.

### BRIEF DESCRIPTION OF THE DRAWINGS

The invention will be described below by way of non-limiting illustration with particular reference to some illustrative examples and the appended figures, wherein:

FIG. 1 shows a sectional view of a wad produced as described in example 1,

FIG. 2 shows a sectional view of a wad according to a different embodiment, which can be used according to the present invention,

FIG. 3 shows a diagram of the trend in CO₂ evolved, as a function of time, over a period of 180 days, according to standard UNI EN ISO 17556:2019, of the wads produced according to example 1, fragmented and directly introduced into soil after their production or introduced into soil after their use (i.e. after firing), in comparison with a reference biodegradable material, specifically pure cellulose, and with a blank composed only of the substrate (soil), and

FIG. 4 shows a diagram of the trend in the percentage biodegradation in soil, as a function of time, over a period of 180 days, according to standard UNI EN ISO 17556:2019, of the same samples as in FIG. 3.

### DETAILED DESCRIPTION OF EMBODIMENTS

As already described, according to the prior art, the presently existing wads are declared biodegradable at a very generic level, often with mention of compostability, and no document speaks of biodegradability in soil. It is unlikely, however, that the wad will be collected and subsequently subjected to a composting process, either for home compost or industrial compost.

The wad according to the present invention aims to have a biodegradability in soil that is declarable, while maintaining the ballistic properties. The biodegradability is assured by the use of biodegradable polyesters and a certain content of thermoplastic starch. Conventionally, a wad functions correctly and has good ballistic properties if, during the firing of a shot, it does not break, maintains the gases generated by the gunpowder, and reaches a velocity of 400 m/s. These results are not easily obtainable with biodegradable materials, which have mechanical properties inferior to those of classic polyolefins. According to the present invention, by using a mixture of biodegradable thermoplastic materials, it is possible to obtain wads with excellent ballistic performances, which withstand very high pressures, and which are biodegradable in soil according to standard UNI EN ISO 17556:2019. The wads produced according to the invention reach a velocity of 420 m/s and pressures of 1050 bar without becoming damaged, while maintaining biodegradability in soil. Furthermore, the moulding of such materials is advantageous because of the low moulding temperatures used, which thus enable energy savings estimated to be about 30% compared to the moulding of traditional wads made of polyolefin materials.

### Example 1. Production of Sample Wads for Cartridges According to the Present Invention

Wads were produced in a cylindrical shape with the following dimensions:
height: 43 mm
diameter: 15 mm
and with the following formulation:
   PBS: 22.86%
   PBAT: 34.28%
   Thermoplastic starch: 42.86%

The thermoplastic starch used was previously obtained by mixing maize starch with 30% by weight of glycerol and extruding the mixture thus obtained at a temperature comprised between 11° and 135° C.

The granules of PBS, PBAT and thermoplastic starch were homogeneously mixed and subsequently fed into a Collin Teach Line ZK25T twin-screw extruder with a thermal profile of 70-120-135-140° C. and a rotation speed of 49.40 RPM (revolutions per minute) to obtain granules of biodegradable material suitable for being used for the production of wads.

The injection moulding process took place under the following conditions: temperature of 120-130° C., holding pressure of 50-60 bar for 1-2 seconds and cycle times of 20-30 seconds.

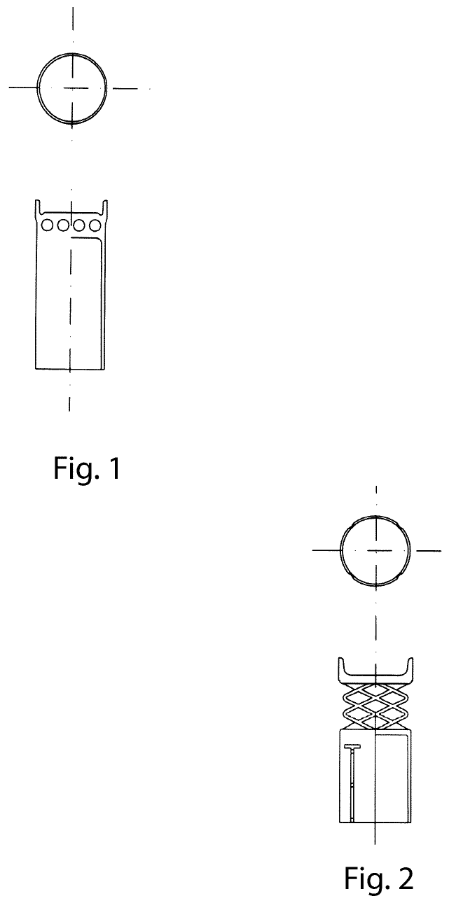

For the purposes of the subsequent ballistic tests, a wad with the shape in cross section shown in FIG. 1 was produced. In this regard, the shape characteristics of the wad are mainly determined for gas sealing. Some wads are specifically produced with a honeycomb structure and can be reinforced by inserting a cardboard disk at the base, to partly attenuate the pressure that forms at the moment of firing, in order to facilitate reaching the gas sealing values necessary to assure an optimal pressure.

For the purposes of the characterisation tests on the wads according to the present invention, it was decided instead to produce wads like the one shown in FIG. 1, without a honeycomb structure and cardboard disk, i.e. with critical characteristics for the purposes of gas sealing. The compliance of such wads with the requirements of the ballistic tests is in itself also a guarantee of conformity of the wads with a honeycomb structure with such requirements. At the same time, wads having a shape like the one shown in FIG. 1 allow for reducing the overall dimensions, to the benefit of the space available for containing the shot, the gunpowder and the primer.

### Example 2. Ballistic Tests

The wads produced in example 1 were subjected to the ballistic test bench, making reference to the standard that regulates the use of wads inside a cartridge. In this regard, as it is not possible to perform an assessment exclusively regarding the ballistic behaviour of the wads, but it is rather necessary to take into consideration the behaviour of the entire cartridge, which, for safety reasons, must comply with precise pressure requirements at the moment of firing a shot, according to the international rules adopted by the Permanent International Commission for the Proof of Small Arms—CIP (Article 8-2 of C.I.P. Decision XV-7 and Article 1.4 of the technical annex to the same decision).

In particular, the tests were conducted by loading the cartridges with a typical amount of gunpowder and with a larger amount. The results are shown in the tables below, in which the abbreviation BT indicates the so-called “barrel time”, i.e. the time (expressed in μs) it takes the wad to leave the barrel after firing; the abbreviation PM indica the pressure, i.e. in particular the pressure (expressed in bar) that is created inside the barrel as a result of the formation of gases caused by the deflagration of the gunpowder, this value being proportional to the amount of gunpowder used; and the abbreviation V1 indicates the velocity (expressed in m/s) of the wad detected upon its exit from the barrel.

Table 1 shows the results of the ballistic tests performed with wads loaded with 32 grams of shot and 1.65 grams of gunpowder (i.e. with a traditional amount of gunpowder).

TABLE 1

| | BT (μs) | PM (bar) | V1 (m/s) |
|---|---|---|---|
| 1 | 2259 | 1038 | 412.5 |
| 2 | 2378 | 948 | 398.6 |
| 3 | 2374 | 943 | 393.0 |
| 4 | 2327 | 974 | 407.8 |
| 5 | 2361 | 964 | 401.7 |
| Mean | 2339.7 | 973.3 | 402.7 |

Table 2 shows the results of ballistic tests conducted with wads loaded with 32 grams of shot and 1.80 grams of gunpowder (i.e. with a larger amount of gunpowder, but in any case within the limit of the test bench, equal to a pressure of 1050 bar).

TABLE 2

| | BT (μs) | PM (bar) | V1 (m/s) |
|---|---|---|---|
| 1 | 2246 | 1069 | 423.6 |
| 2 | 2240 | 1074 | 416.4 |
| 3 | 2239 | 1109 | 418.3 |
| 4 | 2250 | 1062 | 426.2 |
| 5 | 2154 | 1157 | 432.9 |
| 6 | 2229 | 1030 | 432.6 |
| 7 | 2252 | 991 | 422.8 |
| Mean | 2229.9 | 1070.2 | 424.7 |

In the case both of the ballistic tests conducted with wads loaded with 1.65 grams of gunpowder (Table 1) and the ballistic tests conducted with wads loaded with 1.80 grams of gunpowder, the tests were carried out without damaging the wads.

The wads made of biodegradable material according to example 1 thus enabled a velocity of 400 m/sec to be reached, a value obtainable using wads produced with traditionally used materials, such as polyolefins, and typically acceptable for the purpose of firing an adequate shot. In fact, the exit velocity of the wad is proportional to the impact force and thus effectiveness of a shot according to the relationship:

Impact force=mass·velocity²

The wads made of biodegradable material according to example 1, suitably loaded with a larger amount of gunpowder, moreover, enabled even better ballistic performances to be reached, arriving at mean velocities of about 425 m/sec and thus very high impact forces.

### Example 3. Production of Wad Samples for Cartridges According to a Different Embodiment of the Present Invention

Wads with a cylindrical shape were produced, having the same size and shape as the wads produced according to example 1 and with the following formulation:
PBS: 60%
PBAT: 40%

The PBS and PBAT granules were homogeneously mixed and subsequently fed into a Collin Teach Line ZK25T twin-screw extruder with a thermal profile of 70-120-135-140° C. and a rotation speed of 49.40 RPM (revolutions per minute) to obtain granules of biodegradable material suitable for being used for the production of wads.

The injection moulding process took place under the following conditions: temperature of 120-130° C., holding pressure of 50-60 bar for 1-2 seconds and cycle times of 20-30 seconds.

The wads produced according to this example were likewise subjected to ballistic tests according to the same standards used in example 2 and, as was foreseeable, given the structure specifically conceived to attenuate gas leaks, provided results conforming to the relevant requirements.

### Example 4. Tests on Biodegradability in Soil

The wads produced according to examples 1 and 3 were subjected to biodegradation in soil according to standard UNI EN ISO 17556:2019. This international standard specifies a method for determining the ultimate aerobic biodegradability of plastics in soil, by measuring the oxygen demand in a respirometer or the amount of carbon dioxide evolved. According to this standard, the material to be tested is dispersed in soil (after fragmentation), and introduced into a biodegradation vessel (reactor), wherein it is subjected to an intensive bacterial and fungal biodegradation process under controlled conditions of oxygen, temperature and humidity for a test period of at least 180 days, but not to exceed 2 years.

During the aerobic biodegradation of the test material, carbon dioxide, water, minerals and new microbial/fungal cellular components (biomass) are produced. The carbon dioxide produced is continuously monitored by spectroscopic quantitative analysis. In fact, the CO₂ evolved during the biodegradative processes is instrumentally and continuously introduced into a cell for measuring it by means of a non-dispersive infrared system.

The percentage of biodegradation is given by the ratio between the carbon dioxide produced by the material under examination and the theoretical maximum amount of carbon dioxide that can be produced by the material itself. The theoretical maximum amount of carbon dioxide produced is calculated from the total content of organic carbon (TOC) measured. The percentage of biodegradation does not include the amount of carbon converted into new cellular biomass that is not metabolised, in turn, into carbon dioxide during the test.

Biodegradation tests with an easily biodegradable reference material (cellulose) and a blank composed solely of the substrate (soil) were conducted in parallel. In fact, in order to determine the degree of biodegradation of a material, at least the following types of samples must be provided:
a) Test material
b) Reference material
c) Blank (soil)

The reference test time was set equal to 180 days.

The test performed was the biodegradation test in a dynamic respirometer, in an Echo ER24 Respirometer. The biodegradation analyses were performed with the following conditions:
Water: 50% of the water holding capacity;
Temperature: 25±2° C.
Air flow: 250 ml/min, delivered in the presence of water

The biodegradation acceptance level is 60% (with reference to cellulose), which can be reached in a maximum of 6 months.

The percentage of biodegradation for each test reactor (Dₜ) was calculated according to Eq. 1:

$${D}_{t} = \frac{{Σ m}_{T} - {Σ m}_{B}}{ThC {O}_{2}} \cdot 100 \qquad [ Eq . 1 ]$$

where:
m_{T} is the amount of carbon dioxide, in milligrams, evolved in the test reactor FT between the beginning of the test and the time t;
m_{B} is the amount of carbon dioxide, in milligrams, evolved in the blank control reactor FB between the beginning of the test and the time t;
ThCO₂ is the theoretical amount of carbon dioxide, in milligrams, evolved by the material under examination.

The calculation was also applied to obtain the percentage of biodegradation of the reference material in the control reactor.

The theoretical amount of carbon dioxide evolved dal material by the material under examination, in milligrams, is given by Eq. 2:

$${ThCO}_{2} = \frac{44}{12} \cdot m \cdot {w}_{C} \qquad [ Eq . 2 ]$$

where:
m is the mass of the test material, in milligrams, introduced into the test system;
w_{C} is the carbon content of the test material, determined using the chemical formula or elemental analysis, expressed as a fraction of mass;
44 and 12 are the relative molecular and atomic masses of carbon dioxide and carbon, respectively.

The values of TOC and ThCO2 are shown in Table 3, which specifies in particular the carbon content of the cellulose used as a reference (REF) and of the samples under analysis, expressed as a percentage and by weight, and the value of carbon and CO₂ theoretically evolvable [ThCO₂ (mg)]. In particular, in table 3 and hereafter in the description, the abbreviation LB1 NO F indicates crushed granules (<2 mm) of a wad produced according to example 1 and not fired, the abbreviation LB1 FI indicates crushed granules (<2 mm) of a wad produced according to example 1 and which has undergone firing, the abbreviation BA3 NO FI indicates crushed granules (<2 mm) of a wad produced according to example 3 and not fired, the abbreviation BA3 F indicates crushed granules (<2 mm) of a wad produced according to example 3 and which has undergone firing.

TABLE 3

| | Weight | C | C | Th.CO₂ |
|---|---|---|---|---|
| Sample | (mg) | (%) | (mg) | (mg) |
| REF_1 | 6254.6 | 44 | 2752.02 | 10090.8 |
| REF_2 | 6255.9 | 44 | 2752.60 | 10092.9 |
| Mean | 6255.3 | | 2752.3 | 10091.8 |
| BA3 NO FI1 | 6255.7 | 47 | 2940.18 | 10780.7 |
| BA3 NO FI2 | 6250.6 | 47 | 2937.78 | 10771.9 |
| Mean | 6253.2 | | 2939.0 | 10776.3 |
| BA3 FI 1 | 6253.0 | 41 | 2563.73 | 9400.3 |
| BA3 FI 2 | 6253.9 | 41 | 2564.10 | 9401.7 |
| Mean | 6253.5 | | | 9401.0 |
| LB1 NO FI1 | 6253.7 | 46 | 2876.70 | 10547.9 |
| LB1 NO FI2 | 6251.8 | 46 | 2875.83 | 10544.7 |
| Mean | 6252.8 | | | 10546.3 |
| LB1 FI 1 | 6252.5 | 52 | 3251.30 | 11921.4 |
| LB1 FI 2 | 6250.6 | 52 | 3250.31 | 11917.8 |
| Mean | 6251.6 | | | 11919.6 |

The quantification of the CO₂ evolved during the biodegradation of the organic matter of the sample is obtained by continuous monitoring of the CO₂ concentration in the flow exiting the reactor through direct non-dispersive IR detection.

The percentage of biodegradation does not include the amount of carbon converted into new cellular biomass that is not metabolised into carbon dioxide during the test.

The soil composition is the following: soil (74%), perlite (11%), sea sand (10%), peat (5%); water holding capacity (WHC) 56% (established according to ISO 17556:2019), pH 7.6 (ISO 10390:2005). The soil was sieved to obtain particles of less than 2 mm in size. Plants, stones and other inert materials were removed. The marine sand was thoroughly washed with running water, dried in a stove and sieved to remove particles larger than 2 mm.

The fragmented samples were dispersed in a layer of soil, and subsequently introduced into the reactors, which were then connected to the instrument and placed inside the incubation cell. The system was sealed, and the reactors duly identified and then kept away from direct sunlight at a constant temperature (25° C.±2° C.) for a period of 180 days.

Biodegradation was calculated by estimating the CO₂ evolved by the microbial consortium of the substrate loaded with the material, net of the carbon dioxide produced by the substrate alone in the absence of the sample. For the calculation one further considers the theoretical amount of carbon dioxide evolvable by the quantitative conversion of the organic carbon making up the material under examination.

Considering the carbon dioxide evolved (i.e. the sum over time of the contributions of carbon dioxide recorded for every reactor) in relation to the theoretical amount and calculating the ratio to 100 it is possible to estimate the biodegradation of the sample over time.

Table 3 shows the values by weight of the samples introduced into the respective reactors and the theoretical amount of CO₂ calculated by estimating the TOC (carbon content % J).

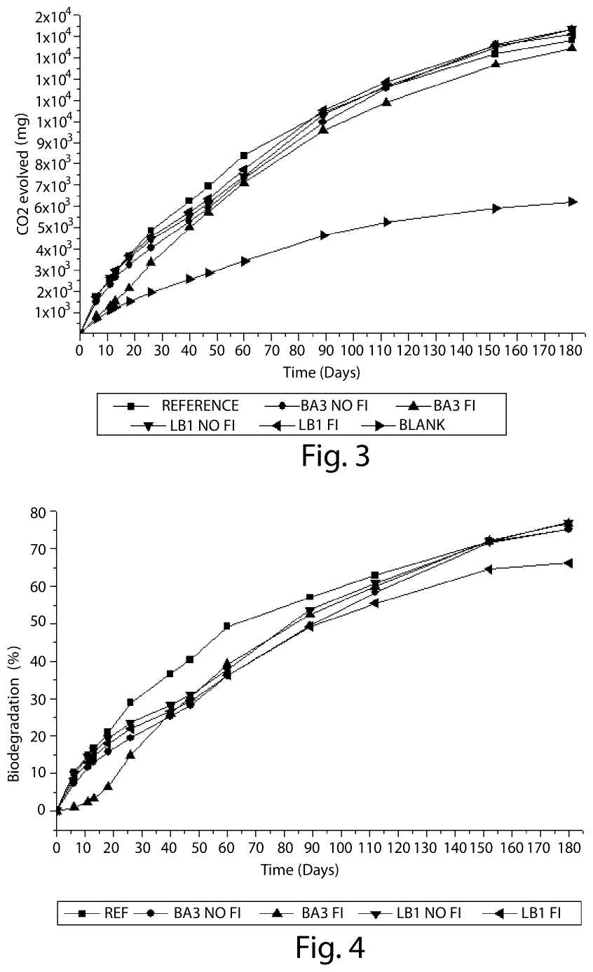

On observing the trend in the curve of CO₂ evolved (FIG. 3) as recorded during the degradation processes within the blank, the reference and the sample, one may note a linear trend and an increase in the biodegradation processes already from the first measurements. At 180 days of biodegradation the carbon dioxide evolved showed to be constant even if slightly decreased compared to the initial period. This trend is typical of biological processes taking place in soil.

The positive slope of the curve, of a higher magnitude than that of the blank, indicates that biodegradation phenomena were still ongoing prevalently in the samples and in the reference.

The trends in biodegradation, expressed in percentages, as a function of time, over a period of 180 days of analysis, are shown in FIG. 4.

As shown in FIG. 4, after 180 days of treatment, the materials subjected to biodegradation in soil show values that are in any case higher than 60% (minimum value required by the standard for the reference material) and in every case comprised between 66% and 77%. In particular, BA3 FL: 77%, BA3 NO FL: 75%, LBP1 FL: 66%, LBP1 NO FF: 77%, whereas cellulose (reference) showed a value of 75%. If one considers the relative biodegradation compared to cellulose, the samples showed a very high biodegradation (above 100% for samples BA3 FI and LB1 NO FI) and 88% for LB1 FI. Considering the positive biodegradation trend, it is possible to assume that 90% will be reached within two years in soil, the percentage that standard UNI EN ISO 17556:2019 establishes must be reached in a period comprised between 180 days and two years.

According to the standard, the samples must reach 90% biodegradation in a period comprised between 180 days and 2 years. Taking account of the perfectly linear trend maintained by the samples as regards the biodegradation processes, it is admissible, by exploiting the equations of the calculable fitting curves, to obtain the days necessary to reach 90% of biodegradation for every sample.

In particular, for the cellulosic reference material, the time it takes to reach a biodegradation percentage of 90% is equal to 184 days, whereas for the wads produced according to example 1, respectively fired and not fired, this time is equal to 184 days and 171 days and for the wads produced according to example 3, respectively fired and not fired, the time is equal to 172 days and 178 days.

The values reported above are all below or just above 180 days and it is thus possible to conclude that the wads produced according to the present invention can be declared biodegradable in soil according to standard UNI EN ISO 17556:2019 (which establishes a time comprised between 180 days and two years).

### Example 5. Toxicity Tests

Another important parameter of the wads for cartridges is nontoxicity for animals, which could ingest the wads scattered in the environment.

In this regard, the PBS and PBAT contained in the wads, given their insolubility in water and in view of the data concerning their toxicity, do not constitute a hazard for the health of a bovine following accidental ingestion.

In fact, as regards the thermoplastic starch, it is an edible substrate easily digestible in bovines. Maize starch, in particular, is to be found as a routine constituent in feed rations intended for bovines and poses no hazard to their health if ingested. Furthermore, glycerol is a molecule characterised by low toxicity and it does not pose a hazard to the health of bovines if accidentally ingested.

It is likewise necessary to consider that the wads produced with the material according to the present invention have no shape characteristics that may have a wounding action on the mucous membranes of the oral cavity or digestive tract. The dimensions of the wads produced with the material according to the present invention thus do not represent a hazard in the event of ingestion.

The material with which the wads are produced are in fact insoluble and the chemical composition thereof poses no problems of toxicity either for animals or the environment, so it is possible to conclude that, at the present state of knowledge, there is no scientific evidence that a wad for cartridges made according to the present invention might represent a hazard for the health of a bovine in the event of accidental ingestion during grazing.

In conclusion, the wads for cartridges according to the present invention allow for pursuing the objectives that had been set of having characteristics of biodegradability in soil certified according to standard UNI EN ISO 17556:2019, as well as being nontoxic both for the environment and for grazing animals which might accidentally ingest them.

Furthermore, moulding the wads produced with the material according to the present invention requires lower moulding temperatures compared to those used for the production of traditional wads made of polyolefin materials, with consequent energy savings of about 30% compared to moulding the wads according to the prior art.

The present invention has been described by way of non-limiting illustration, according to the preferred embodiments thereof, but it is to be understood that variations and/or modifications may be introduced by persons skilled in the art without going beyond the relevant scope of protection, as defined by the appended claims.

1-10. (canceled)

11. A wad for cartridges with characteristics of biodegradability in soil, the wad comprising: a mixture of biodegradable materials, said mixture consisting of poly(butylene succinate) (PBS), poly(butylene adipate terephthalate) (PBAT) and thermoplastic maize starch (TPS), wherein said mixture comprises from 8 to 65% by weight of PBS, from 12 to 50% by weight of PBAT and up to a maximum of 80% by weight of TPS.

12. The wad for cartridges according to claim 11, wherein said thermoplastic maize starch (TPS) is obtained by extrusion of maize starch with a plasticiser.

13. The wad for cartridges according to claim 12, wherein said plasticiser is glycerol.

14. The wad for cartridges according to claim 13, wherein said thermoplastic maize starch (TPS) is produced by extrusion starting from 70% by weight of maize starch and 30% by weight of glycerol.

15. The wad for cartridges according to claim 11, wherein said mixture comprises from 8 to 30% by weight of PBS, from 12 to 40% by weight of PBAT and from 30 to 80% by weight of TPS.

16. The wad for cartridges according to claim 15, wherein said mixture comprises 22.86% by weight of PBS, 34.28% by weight of PBAT and 42.86% by weight of TPS.

17. The wad for cartridges according to claim 11, wherein the wad is biodegradable in soil according to standard UNI EN ISO 17556:2019.
